(19) United States
(12) Patent Application Publication
(10) Pub. No.: US 2024/0054367 A1
(43) Pub. Date: Feb. 15, 2024

(54) METHODS FOR GRAPH-BASED SMART GAS DATA MANAGEMENT AND INTERNET OF THINGS (IOT) SYSTEMS

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Bin LIU, Chengdu (CN)

(73) Assignee: CHENGDU QINCHUAN IOT TECHNOLOGY CO., LTD., Chengdu (CN)

(21) Appl. No.: 18/494,752

(22) Filed: Oct. 25, 2023

(30) Foreign Application Priority Data
Sep. 12, 2023 (CN) 202311169988.X

(51) Int. Cl. G06N 5/04; G06N 5/022

(52) U.S. Cl. CPC G06N 5/04; G06N 5/022

(57) ABSTRACT

Embodiments of the present disclosure provide a method for graph-based smart gas data management and an Internet of Things system. The method includes: obtaining gas data and source characteristics corresponding to the gas data from a predetermined knowledge graph; dividing the gas data based on the source characteristics to determine one or more sets of sub-gas data; determining a processing priority of the sub-gas data based on at least one of a degree of data anomaly and a degree of data completeness of the sub-gas data; determining a resource allocation strategy for computing resources and a processing strategy for the sub-gas data based on the processing priority of the one or more sets of sub-gas data; the processing strategy including a processing algorithm and the computing resources; and the processing algorithm including at least one of a data normalization algorithm, an outlier detection algorithm, and a data quality analysis algorithm.

### CROSS-REFERENCE TO RELATED APPLICATION

The application claims priority of Chinese Patent Application No. 202311169988.X, filed on Sep. 12, 2023, the entire contents of which are incorporated herein by reference.

### TECHNICAL FIELD

The present disclosure relates to the field of information management, and in particular, to a method for graph-based smart gas data management and an Internet of Things (IoT) system.

### BACKGROUND

With the increasing application of gas in daily life, the gas management system has become more digitalized. In order to enhance the management capabilities of the gas system and improve the service quality to gas users, it is necessary to efficiently and quickly process the massive amount of data from the gas pipeline network, and effectively identify and filter the data, ultimately enabling separate data processing.

To address the issue of identifying and filtering massive data, CN107330125B proposes a method for integrating massive unstructured distribution network data based on knowledge graph technology. The application focuses on constructing a local index of data based on a local knowledge graph according to the processed data. This local index of data is then sent to a data management center, which constructs a global index of data based on the global knowledge graph. However, due to the unique and extensive nature of gas data, as well as the limited computing resources available, it is still necessary to filter the gas data and determine the allocation strategy for computing resources.

Therefore, it is desired to provide a method for graph-based smart gas data management and an Internet of Things (IoT) system to achieve a rational allocation of computing resources for gas data.

### SUMMARY

One or more embodiments of the present disclosure provide a method for graph-based smart gas data management. The method is performed by a gas data center of an Internet of Things (IoT) system for smart gas, comprising: obtaining gas data and source characteristics corresponding to the gas data from a predetermined knowledge graph; wherein the predetermined knowledge graph is constructed based on gas data obtained from a smart gas platform, the gas data includes at least one of device operation data, gas monitoring data, and user behavior data, and the source characteristics include at least one of a source platform, a source object, and a source collection device; and nodes in the predetermined knowledge graph include entity nodes and attribute value nodes, the entity nodes include at least one of a gas user node, a gas device node, a gas pipeline node, and a staff node, and edges in the predetermined knowledge graph are determined based on a structure of a gas pipeline network; dividing the gas data based on the source characteristics to determine one or more sets of sub-gas data; determining a processing priority of the sub-gas data based on at least one of a degree of data anomaly and a degree of data completeness of the sub-gas data; wherein the degree of data anomaly and the degree of data completeness are determined based on the predetermined knowledge graph; determining a resource allocation strategy for computing resources and a processing strategy for the sub-gas data based on the processing priority of the one or more sets of sub-gas data; and the processing strategy including a processing algorithm and the computing resources; and the processing algorithm including at least one of a data normalization algorithm, an outlier detection algorithm, and a data quality analysis algorithm.

One of the embodiments of the present disclosure provides an Internet of Things (IoT) system for smart gas, the IoT system for smart gas comprises a smart gas management platform, the smart gas management platform comprises a smart gas data center, and the smart gas data center is configured to perform the above-described method for graph-based smart gas data management.

One or more embodiments of the present disclosure provide a non-transitory computer-readable storage medium storing computer instructions, wherein when reading the computer instructions in the storage medium, a computer executes the above-described method for graph-based smart gas data management.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a diagram of a platform structure of an Internet of Things (IoT) system for smart gas according to some embodiments of the present disclosure;

FIG. 2 is an exemplary flowchart of a method for graph-based smart gas data management according to some embodiments of the present disclosure;

FIG. 3 is an exemplary schematic diagram of a predetermined knowledge graph according to some embodiments of the present disclosure;

FIG. 4 is an exemplary flowchart for determining an updated processing priority according to some embodiments of the present disclosure; and

FIG. 5 is an exemplary schematic diagram of factors influencing processing requirement characteristics according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “device,” “unit,” and/or “module” used herein are one method to distinguish different components, elements, parts, sections, or assemblies of different levels in ascending order. However, the terms may be displaced by other expressions if they may achieve the same purpose.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts. The terminology used herein is for the purposes of describing particular examples and embodiments only and is not intended to be limiting. As used herein, the singular forms “a,” “an,” and “the” may be intended to include the plural forms as well, unless the context clearly indicates otherwise.

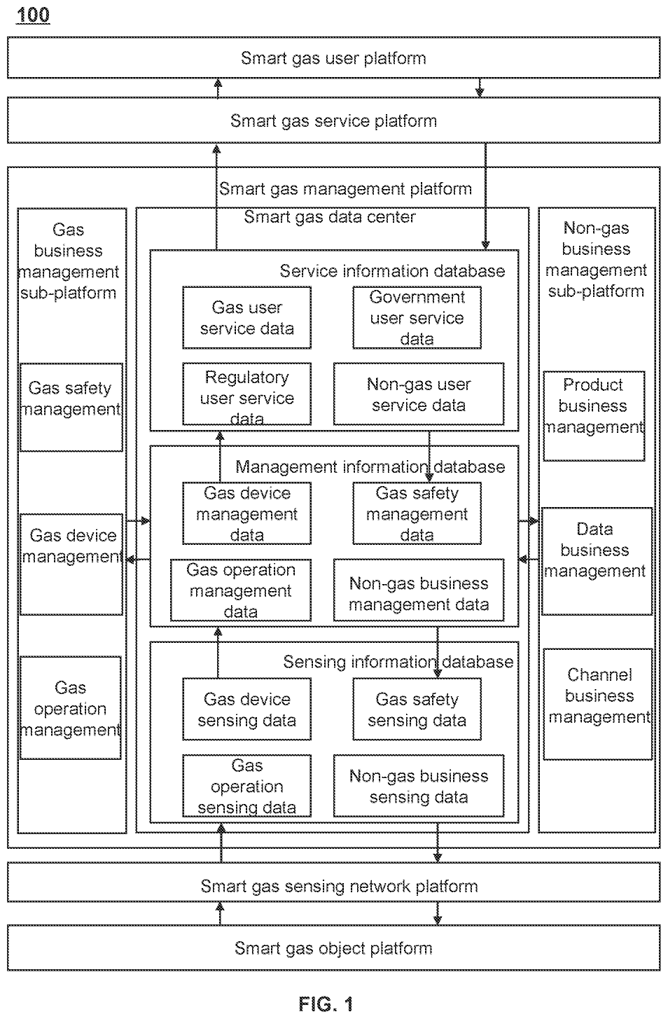

FIG. 1 is a diagram of a platform structure of an Internet of Things (IoT) system for smart gas according to some embodiments of the present disclosure.

As shown in FIG. 1, the IoT system 100 for smart gas includes a smart gas user platform, a smart gas service platform, a smart gas management platform, a smart gas sensing network platform, and a smart gas object platform connected in sequence.

The smart gas user platform may be a platform for interacting with users. In some embodiments, the smart gas user platform may be configured as a terminal device.

In some embodiments, the smart gas user platform may be used to collect user behavior data (e.g., each payment record of a user, each gas usage record of a user, etc.).

The smart gas service platform may be a platform for receiving gas user information and transmitting data and/or information such as control instructions, processing strategies, or the like. The smart gas service platform may obtain gas user behavior data, etc., from the smart gas user platform and send it to the smart gas management platform.

The smart gas management platform may be a platform that coordinates and harmonizes the connection and collaboration between various functional platforms, aggregates all the information of the Internet of Things, and provides perception management and control management functions for the Internet of Things operation system.

In some embodiments, the smart gas management platform may include a plurality of smart gas management sub-platforms and a smart gas data center. The smart gas management sub-platform may include a gas business management sub-platform and a non-gas business management sub-platform.

The gas business management sub-platform may be used for managing gas business. In some embodiments, the gas business management sub-platform may include but is not limited to modules for gas safety management, gas device management, and gas operation management. The gas business management sub-platform may analyze and process related data of gas business through the aforementioned modules.

The non-gas business management sub-platform may be used for managing non-gas business. In some embodiments, the non-gas business management sub-platform may include but is not limited to modules for product business management, data business management, and channel business management. The non-gas business management sub-platform may analyze and process related data of non-gas business through the aforementioned modules.

The smart gas data center may be used for storing and managing all operational information of the IoT system 100 for smart gas. In some embodiments, the smart gas data center may be configured as a storage device, including a service information database, a management information database, and a sensing information database.

In some embodiments, the service information database may include gas user service data, government user service data, regulatory user service data, and non-gas user service data; the management information database may include gas device management data, gas safety management data, gas operation management data, and non-gas business management data; and the sensing information database may include gas device sensing data, gas safety sensing data, gas operation sensing data, and non-gas business sensing data.

In some embodiments, the management information database may interact with the gas business management sub-platform and the non-gas business management sub-platform, respectively. For example, the smart gas data center may obtain gas business management data from the gas business management sub-platform and non-gas business management data from the non-gas business management sub-platform via the management information database.

In some embodiments, the smart gas management platform may interact with the smart gas service platform and the smart gas sensing network platform through the smart gas data center. For example, the smart gas data center may send gas user service data to the smart gas service platform through the service information database. For example, the smart gas data center may send instructions for obtaining gas device sensing data to the smart gas sensing network platform via the sensing information database.

In some embodiments, the smart gas data center may be used to determine processing requirement characteristics of sub-gas data based on at least one of a degree of data anomaly and a degree of data completeness of the sub-gas data; and determine a processing priority of the sub-gas data based on the processing requirement characteristics of the sub-gas data and data characteristics of the sub-gas data. In some embodiments, the smart gas data center may update the processing priority to determine the updated processing priority. In some embodiments, the smart gas data center may also determine a resource allocation strategy for available computing resources and a processing strategy for the sub-gas data.

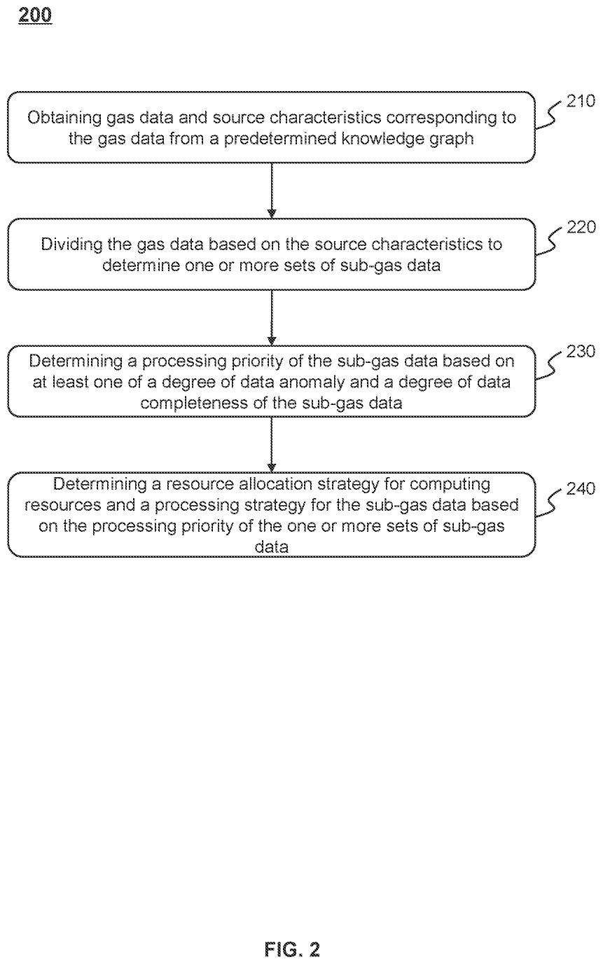

More on the above section may be found in the related descriptions of FIGS. 2-5.

The smart gas sensing network platform may be a functional platform for managing sensing communications. In some embodiments, the smart gas sensing network platform may perform the functions of sensing communication for perception information and sensing communication for control information.

In some embodiments, the smart gas sensing network platform may interact with the smart gas data center and the smart gas object platform. For example, the smart gas sensing network platform transmits instructions for obtaining gas device operation data and/or gas monitoring data to the smart gas object platform. As another example, the smart gas sensing network platform uploads the device operation data and/or gas monitoring data to the smart gas management platform.

The smart gas object platform may be a functional platform for generation of the perception information and execution of the control information. For example, the smart gas object platform may monitor and generate operation information of gas pipeline network devices.

In some embodiments, the smart gas object platform may be used to obtain gas device operation data and/or gas monitoring data.

In some embodiments, the gas device operation data may include parameters of the gas device during operation, such as the switching of valves, the power of gas transmission devices, etc.; the gas monitoring data may include gas-related data collected by the monitoring device, such as readings of a gas flow meter, data of a gas pipeline monitored by a temperature sensor, data of a gas pipeline monitored by a pressure sensor, etc.

In some embodiments of the present disclosure, the Internet of Things system 100 for smart gas based on information management of the smart gas data center may form a closed loop of information operation between the smart gas object platform and the smart gas user platform, and operate in a coordinated and regular manner under the unified management of the smart gas management platform, so as to realize the informatization and intellectualization of the information management of the smart gas data center.

FIG. 2 is an exemplary flowchart of a method for graph-based smart gas data management according to some embodiments of the present disclosure. In some embodiments, process 200 may be performed based on the smart gas data center of the smart gas management platform. As shown in FIG. 2, the process 200 includes the following steps:

Step 210, obtaining gas data and source characteristics corresponding to the gas data from a predetermined knowledge graph.

In some embodiments, the smart gas data center may process basic gas data obtained from the smart gas platform to construct the predetermined knowledge graph. In some embodiments, the smart gas platform includes at least a smart gas service platform, a smart gas management platform, and a smart gas sensing network platform.

The basic gas data refers to data information related to gas. In some embodiments, the basic gas data may include at least one of device operation data, gas monitoring data, and user behavior data. Gas data is data involved in the calculation and processing of the basic gas data. For example, the basic gas data may be operation data corresponding to attribute value nodes. More details about the attribute value nodes may be found in the following description.

The device operation data refers to parameters of gas device operation configured in the smart gas object platform, such as an operating power of a gas transmission device and switch information of a valve control device. The gas monitoring data refers to gas-related data collected by a gas monitoring device, such as readings of a gas flow meter, data of a gas pipeline monitored by a temperature sensor, and data of a gas pipeline monitored by a pressure sensor. The user behavior data refers to data related to the recorded operation behavior of gas users, such as payment records and gas usage records.

The predetermined knowledge graph is a pre-set graph used to represent the relationships between various information in gas data.

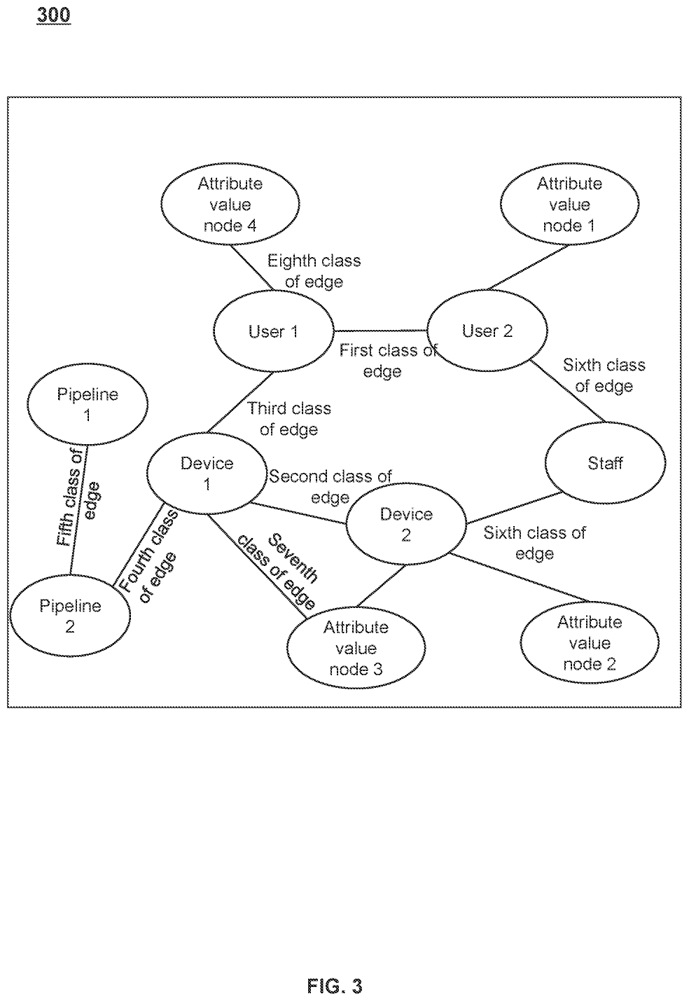

FIG. 3 is an exemplary schematic diagram of a predetermined knowledge graph according to some embodiments of the present disclosure.

As shown in FIG. 3, the predetermined knowledge graph 300 includes a plurality of nodes and edges. The nodes in the predetermined knowledge graph may include entity nodes and attribute value nodes.

The entity node refers to a node corresponding to an entity related to gas data. In some embodiments, the entity nodes may include gas user nodes, gas device nodes, gas pipeline nodes, or staff nodes.

The gas user node refers to a node corresponding to a user. As shown in FIG. 3, the gas user nodes may include nodes such as user 1, user 2, and so on. The users corresponding to the gas user nodes may include gas users, regulatory users, government users, or the like.

The gas device node refers to a node corresponding to a gas device, such as a gas meter node, a gas valve node, etc. As shown in FIG. 3, gas device nodes may include nodes such as device 1, device 2, etc.

The gas pipeline node refers to a node corresponding to a gas pipeline. As shown in FIG. 3, gas pipeline nodes may include nodes such as pipeline 1, pipeline 2, etc.

The staff node refers to a node representing gas staff. The gas staff may be constructed as a staff node. For example, a staff node corresponds to a person assigned to supervise a certain gas device.

Some embodiments of the present disclosure introduce staff nodes into the predetermined knowledge graph, which can reflect the relationship or degree of association between gas staff and other entity nodes, and help obtain more comprehensive gas data and its corresponding source characteristics.

The attribute value node refers to a node in the predetermined knowledge graph that represents an attribute value of an attribute contained in an entity node. Different entity nodes may correspond to different attribute value nodes. For example, attribute value nodes corresponding to gas user nodes may include an address node, a household population node, a gas usage record node for a certain day, a repair record node, etc.; attribute value nodes corresponding to gas device nodes may include a device installation location node, a device operation data node, etc.

In some embodiments, for attribute value nodes (e.g., addresses, etc.) that are updated infrequently, the actual address of the gas user may be directly used as the attribute value node. For attribute value nodes that are updated frequently, batch construction may be used to ensure that the complexity of the knowledge graph is within a reasonable range and the computing workload of graph construction is reduced.

In some embodiments, when an update frequency of a value of an attribute value node connected to an entity node is greater than a preset threshold, the attribute value node needs to be constructed in batches. The preset threshold may be determined based on historical experience or expert opinion. For example, when the update frequency of the operation data is greater than the preset threshold, the preset count of pieces of operation data may be used as a value of an attribute value node of a operation data attribute. As another example, the operation data within each preset time period may be used as a value of an attribute value node of an operation data attribute, where the preset count and the preset time period may be determined based on an actual situation.

The edges of the predetermined knowledge graph are used to connect different nodes, and the characteristics of the edges may represent the relationships between different nodes. As shown in FIG. 3, the edges may be categorized into different types based on the relationships they represent. For example, the edges may include a first type of edges, . . . , an eighth type of edges, etc., which correspond to relationship 1, . . . relationship 8, etc., respectively.

Merely by way of example, relationship 1 may indicate an inter-address relationship, such as neighbors, same floor, same neighborhood, etc. Relationship 2 may indicate an inter-gas device relationship, such as connection, control, etc. Relationship 3 may indicate an inter-relationship between gas users and gas device, such as installation in, monitoring, etc. For example, device 1 is installed in the user 1's home or device 1 is responsible for monitoring user 1's data. Relationship 4 may indicate the relationship between gas device and gas pipelines, such as upstream, downstream, monitoring, etc. For example, device 1 monitors the data of pipeline 2. Relationship 5 may indicate the relationship between gas pipelines, such as upstream, downstream, etc. Relationship 6 may indicate the relationship between gas staff and gas users, gas device, such as responsible for, supervise, etc. Relationship 7 may indicate the relationship between attributes included in a gas device and the gas device, such as collection, installation location, etc. Relationship 8 may indicate the attributes included the relationship between attributes of a gas user and the gas user, such as record relationship, etc.

In some embodiments, edges of a type corresponding nodes that have a correspondence relationship may be generated by connecting the nodes. For example, in FIG. 3, if user node 1 and user node 2 correspond to neighboring users, a first class of edges may exist between the user node 1 and user node 2.

The source characteristics refer to characteristics related to the source of gas data collection. In some embodiments, the source characteristics may include at least one of a source platform, a source object, and a source collection device.

The source platform is a platform that collects gas data, such as the smart gas service platform, smart gas sensing network platform, and smart gas management platform. The source object may include devices, users, or the like. In some embodiments, the source object is represented in the predetermined knowledge graph as a gas device node connected via a seventh class of edges to an attribute value node corresponding to the gas data attribute. The source collection device refers to a device used for collecting gas data. For example, attribute value node 3 corresponding to gas data 1 is connected to device node 1 corresponding to device 1 and device node 2 corresponding to collection device X based on the seventh class of edges. Based on the knowledge graph, it may be determined that gas data 1 is working data collected by the collection device X for the device 1 and is input into the smart gas data center through the smart gas sensing network platform. The source platform of the gas data 1 is the smart gas sensing network platform, the source object is the device 1, and the source collection device is the collection device X.

In some embodiments, the smart gas data center may determine the attribute value node corresponding to the gas data and the gas device node connected to the attribute value node through the seventh class of edges based on the predetermined knowledge graph, thereby obtaining the gas data and its corresponding source characteristics.

Step 220, dividing the gas data based on the source characteristics to determine one or more sets of sub-gas data.

The sub-gas data refers to a set or sets of gas data obtained by dividing the gas data. In some embodiments, each set of sub-gas data corresponds to a person and/or device with the same source characteristics.

In some embodiments, the smart gas data center may divide the gas data based on the type of gas data. For example, the smart gas data center may divide the gas data into device operation data, data that monitors the temperature inside the gas pipeline, and user gas usage data.

In some embodiments, the smart gas data center may aggregate the divided gas data with the same source characteristics to obtain one or more sets of sub-gas data. For example, the smart gas data center may aggregate the gas data from a class of collection devices to obtain a set of sub-gas data.

Step 230, determining a processing priority of the sub-gas data based on at least one of a degree of data anomaly and a degree of data completeness of the sub-gas data.

The degree of data anomaly refers to a degree of quality anomaly in the sub-gas data.

The degree of data completeness is a parameter that characterizes the degree of completeness of the sub-gas data.

In some embodiments, the smart gas data center may determine the degree of data anomaly of the current sub-gas data based on whether other entity nodes associated with the node corresponding to the sub-gas data are abnormal in the predetermined knowledge graph. For example, when there are abnormal entity nodes among the entity nodes directly connected to the node corresponding to the sub-gas data, the sub-gas data is considered to be abnormal. Moreover, the greater the count of aforesaid abnormal entity nodes, the greater the degree of anomaly of the sub-gas data.

The node corresponding to the sub-gas data may be understood as the node that serves as the provenance of the sub-gas data. For example, if the sub-gas data is operation data of device A in a certain historical time period, the node corresponding to the sub-gas data is a node of an attribute value corresponding to the operation data. Moreover, the entity nodes that are directly connected to the node corresponding to the sub-gas data include a device node corresponding to device A.

In some embodiments, the smart gas data center may determine whether other entity nodes associated with the node corresponding to the sub-gas data are anomalous based on algorithms such as OddBall algorithm.

In some embodiments, the smart gas data center may determine the degree of data completeness based on the accuracy and frequency of data collection. In some embodiments, the degree of data completeness is positively correlated with the accuracy and frequency of data collection.

The accuracy and frequency of data collection may be determined from the predetermined knowledge graph. In some embodiments, the smart gas data center may compare the sub-gas data with historical sub-gas data to obtain the accuracy of data collection. The historical sub-gas data for comparison may be historical sub-gas data with the same source characteristics as the sub-gas data. For example, if the sub-gas data is environmental parameter data of device 1, and it is known from the knowledge graph that the historical environmental parameter data includes data with four attributes, namely, ambient humidity, ambient temperature, ambient light intensity, and ambient pressure, while the current environmental parameter data only includes data with two attributes, namely, ambient humidity and ambient temperature. Therefore, the accuracy of data collection of the current environmental parameter data is 50%. In some embodiments, the gas data may obtain the frequency of data collection based on the predetermined knowledge graph from an attribute value node which is connected to the gas user node through an eighth class of edges and an attribute value node which is connected to the gas device node through a seventh class of edges.

The processing priority refers to an order in which different sub-gas data are processed.

In some embodiments, the smart gas data center may determine the processing priority of the sub-gas data based on at least one of the degree of data anomaly and the degree of data completeness of the sub-gas data in various ways. For example, the smart gas data center may establish a processing priority reference table based on the correspondence between the degree of data anomaly, the degree of data completeness, and the processing priority, and determine the processing priority of the sub-gas data by checking the table. The greater the degree of data anomaly, and/or the greater the degree of data completeness, the higher the processing priority of the sub-gas data may be.

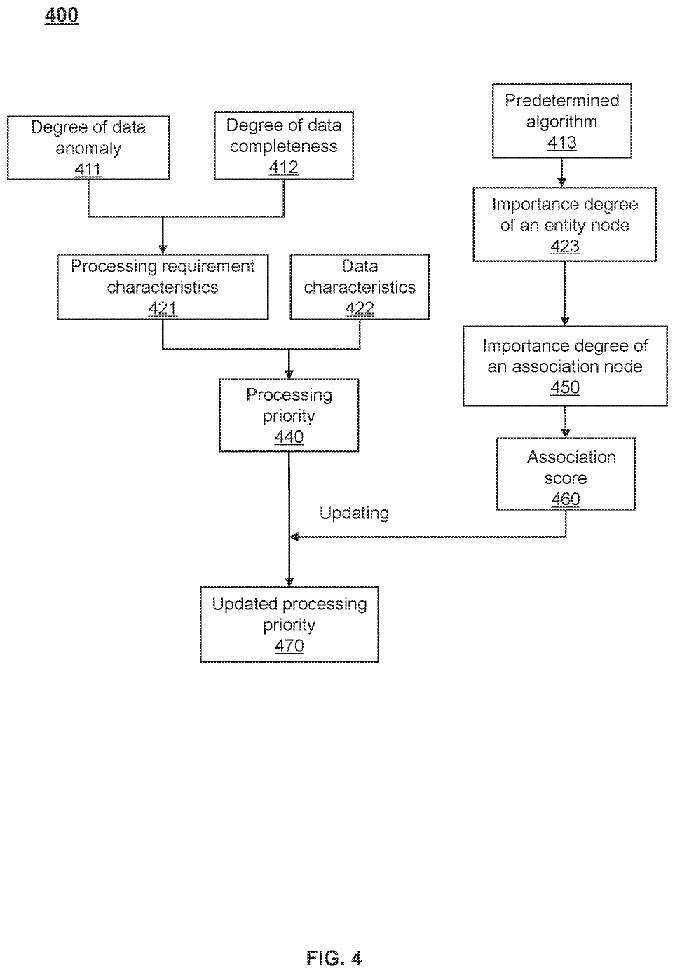

In some embodiments, the smart gas data center may also determine the processing priority in other ways, more of which may be seen in FIG. 4 and its related description.

Step 240, determining a resource allocation strategy for computing resources and a processing strategy for the sub-gas data based on the processing priority of the one or more sets of sub-gas data. The computing resources refer to resources required to process data, such as CPU resources, memory resources, hard disk resources, etc.

The resource allocation strategy refers to an allocation situation of computing resources allocated to the sub-gas data. For example, the resource allocation strategy may include assigning CPU resources, memory resources, etc., to certain sub-gas data.

The processing strategy refers to a strategy for processing the sub-gas data. In some embodiments, the processing strategy may include a processing algorithm. The processing algorithm may include various algorithms. For example, a first processing algorithm performs only data standardization processing on the sub-gas data; a second processing algorithm performs data standardization processing, missing value processing, and outlier checking and processing on the sub-gas data; and a third processing algorithm performs data standardization processing, missing value processing, outlier checking and processing, and quality analysis on the sub-gas data.

In some embodiments, the smart gas data center may determine the resource allocation strategy for computing resources and the processing strategy based on the processing priority by various manners. For example, the smart gas data center may determine the resource allocation strategy for computing resources and the processing strategy based on a preset rule. Illustratively, the preset rule may be: the higher the processing priority, the more the computing resources allocated to the sub-gas data in the resource allocation strategy, and the more complex the processing algorithm in the processing strategy. For example, if the processing priority is higher than a preset priority threshold for the sub-gas data, the processing strategy is to use a third processing algorithm for processing.

In some embodiments, the preset rule may also include an importance degree of the node corresponding to the sub-gas data, where a greater importance degree results in a more complex processing algorithm in the processing strategy. For a description of the importance degree, refer to the related description in FIG. 4.

In some embodiments, the smart gas data center may obtain currently available computing resources; and determine a resource allocation strategy for the available computing resources and the processing strategy for the sub-gas data based on the processing priority, data characteristics, and the available computing resources of the one or more sets of the sub-gas data.

The available computing resources refer to unallocated computing resources in the current smart gas data center.

In some embodiments, the smart gas data center may separately obtain the total computing resources and the allocated computing resources, and the remaining computing resources are recognized as the available computing resources.

The data characteristics refer to characteristics associated with the sub-gas data, such as the amount of the sub-gas data.

The resource allocation strategy for available computing resources refers to a allocation scheme of available computing resources for each set of sub-gas data.

In some embodiments, the resource allocation strategy for the available computing resources may be determined based on the processing priority, the data characteristics, and the available computing resources. For example, for sub-gas data with a lower processing priority and/or smaller data characteristics, fewer computing resources may be allocated; and as the available computing resources decrease, the computing resources allocated to each set of sub-gas data decrease accordingly.

In some embodiments, the smart gas data center may determine the processing strategy for the sub-gas data by querying a control table based on the processing priority, data characteristics, and available computing resources. The control table may pre-record the processing strategy for the sub-gas data corresponding to different processing priorities, data characteristics, and available computing resources.

In some embodiments of the present disclosure, by determining the resource allocation strategy for computing resources and the processing strategy for sub-gas data through the processing priority, data characteristics, and available computing resources, limited available computing resources can be reasonably allocated and the computing resources can be fully and comprehensively utilized, thereby avoiding insufficient computing resources for processing sub-gas data and improving the efficiency of gas data processing.

In some embodiments of the present disclosure, the relationship between each entity node and attribute value node may be reflected by the predetermined knowledge graph. The predetermined knowledge graph may be analyzed and processed to obtain the attributes of different entity nodes. For example, based on the predetermined knowledge graph, the relationship between a certain gas user and other gas users and gas device, as well as information such as the address and gas usage of the gas user, may be determined. Through the construction of the predetermined knowledge graph, the scattered and extensive variety of gas data and their attributes may be effectively organized. This helps in quickly and efficiently obtaining the gas data and their corresponding source characteristics from the predetermined knowledge graph. Based on the predetermined knowledge graph, the processing priority of the sub-gas data may be determined to establish the resource allocation strategy of computing resources and the processing strategy of the sub-gas data. This allows for different processing of complex gas data, fine processing of complex and important data, and simple processing of secondary data, realizing the smart management of gas center information processing.

FIG. 3 is an exemplary schematic diagram for determining an updated processing priority according to some embodiments of the present disclosure.

In some embodiments, the smart gas data center may determine processing requirement characteristics 421 of sub-gas data based on a degree of data anomaly 411 and a degree of data completeness 412 of the sub-gas data; and determine a processing priority 440 of the sub-gas data based on the processing requirement characteristics 421 and data characteristics 422 of the sub-gas data.

In some embodiments, the degree of data anomaly may be determined based on an anomaly of a target node, and more description of the degree of data anomaly 411 and the degree of data completeness 412 may be found in FIG. 2.

The target node is an association node of a node corresponding to historical sub-gas data corresponding to the sub-gas data. The historical sub-gas data corresponding to the sub-gas data may be found in FIG. 2 and its associated description, and a description of the node corresponding to the historical sub-gas data may be found in the preceding description of the nodes corresponding to the sub-gas data.

The associated nodes of a certain node are other nodes that are directly connected to the node. In some embodiments, the smart gas data center may determine the association nodes of each node by reading the predetermined knowledge graph.

The processing requirement characteristics are characteristics used to reflect the extent to which the sub-gas data is necessary to be processed. The processing requirement characteristics may include processing necessity, for example, the processing requirement characteristics of sub-gas data with a high probability of anomalies is greater than that of sub-gas data with a low probability of anomalies. Similarly, the processing requirement characteristics of important data is greater than that of non-important data.

In some embodiments, the smart gas data center may determine the processing requirement characteristics in a variety of ways based on the degree of data anomaly 411 and the degree of data completeness 412. For example, the processing requirement characteristics=a*degree of data anomaly+b*degree of data completeness, where a and b are constants determined based on experience. Understandably, the higher the degree of data anomaly and the higher the degree of data completeness of the sub-gas data, the larger the processing requirement characteristics.

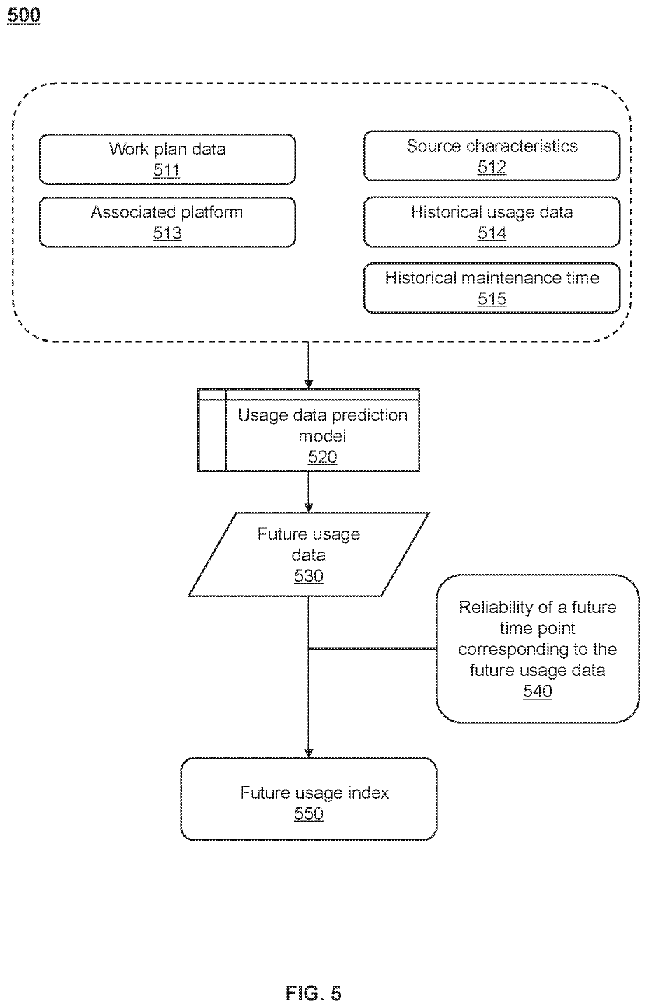

In some embodiments, the processing requirement characteristics may also be related to a future usage index and a reliability of a future time point corresponding to future usage data, more of which may be seen in FIG. 5 and its related description.

In some embodiments, the smart gas data center may retrieve the data characteristics of the sub-gas data based on the knowledge graph. For more description of the data characteristics may be found in FIG. 2 and its related description. For example, the smart gas data center may retrieve the value of the attribute value node corresponding to the amount of the sub-gas data, thereby obtaining the data characteristics of the sub-gas data.

In some embodiments, the smart gas data center may establish a processing priority reference table based on the processing requirement characteristics 421, the data characteristics 422, and corresponding processing priorities 440. The processing priorities may be determined by referencing the table.

In some embodiments, the processing priority of the sub-gas data is also related to an association score of the sub-gas data. The smart gas data center may determine an importance degree of an entity node 423 based on a predetermined algorithm 413, determine an importance degree of an association node 450 based on the importance degree of the entity node 423, determine the association score 460 of the sub-gas data based on the importance degree of the association node 450, update the processing priority 440 based on the association score 460, and determine an updated processing priority 470.

The predetermined algorithm 413 refers to a pre-defined algorithm used to calculate the importance degree of the entity node. In some embodiments, different entity nodes may have different predetermined algorithms.

The importance degree of the entity node 423 is a parameter used to reflect the importance of the entity node. In some embodiments, the smart gas data center may determine the importance degree of the entity node based on the predetermined algorithm.

For example, an importance degree of a gas user node may be an importance degree of the gas user, which may be positively correlated with gas usage, user energizing time, and on-time payment probability in the predetermined algorithm. The importance degree of a staff node may be positively related to an employment duration and user ratings. The importance degree of a gas device node may be positively related to a count of association nodes and a price of the gas device.

In some embodiments, an importance degree of a gas pipeline node may be calculated based on a pipeline graph using a preset algorithm as follows: the importance degree of the gas pipeline node=Σᵢ₌₁ⁿ kᵢ*cᵢ, where n is a count of paths from the gas pipeline node to all other types of entity nodes according to a direction of gas flow; k is a path coefficient; and c is an importance degree of an end node corresponding to the path coefficient. The end node refers to a node whose in-degree is not 0 and whose out-degree is 0.

In some embodiments, the pipeline graph may be determined based on a predetermined knowledge graph, where the pipeline graph is a subgraph of the predetermined knowledge graph. For example, the nodes in the pipeline graph may be remaining nodes in the predetermined knowledge graph excluding the attribute value nodes and staff nodes. The edges in the pipeline graph represent flow paths of the gas and may be directed edges, with the direction indicating the flow direction of the gas.

After flowing to a certain node, the gas no longer flows to other nodes, then the node is the end node in the pipeline map The determination of the importance degree of the end nodes is the same as the determination of the importance degree of the gas user nodes, gas device nodes, and staff nodes as described previously. Please refer to the previous section for more descriptions.

In some embodiments, the path coefficient is positively correlated with the path length. The path length refers to a count of nodes the path passes through from a gas pipeline node to an end node in the pipeline graph. In other words, the path length may be represented by a neighborhood degree of the start and end points of the path in the pipeline graph. For example, a path from gas pipeline node A to gas user node C may be denoted as A-B-C, where gas user node C is the end node of the path. The neighborhood degree of nodes A and C is 2, indicating that the length of the path from gas pipeline node A to gas user node C is 2.

It is understandable that the more upstream and branching the gas pipeline node is, the more important it is.

In some embodiments, the determination of the importance degree of the entity node may be performed when computing resources are not constrained or at regular intervals to avoid immediate determinations that consume computing resources and delay other data processing.

The importance degree of the association node 450 of the sub-gas data refers to the importance of the association nodes of the nodes corresponding to the sub-gas data in the predetermined knowledge graph.

In some embodiments, after determining the association nodes of the nodes corresponding to the sub-gas data, the smart gas data center determines the importance degree of the association node 450 of the sub-gas data based on the importance degree of the entity node 423.

The association score 460 is a score used to characterize the degree to which the sub-gas data is associated with other entities.

In some embodiments, the association score may be related to a count of associated entities and the total importance degree of the associated entities, for example, the higher the count of associated entities and the higher the total importance degree of the associated entities, the higher the association score accordingly. The count of associated entities may be expressed based on the count of entity nodes in the association nodes of the nodes corresponding to the sub-gas data, and the total importance degree of the associated entities may be expressed based on a sum of the importance degrees of the entity nodes in the association nodes of the nodes corresponding to the sub-gas data.

In some embodiments, when the association score is greater than the first threshold, the data processing center may update the previously determined processing priority 440 and determine an updated processing priority 470. For example, the sub-gas data has a processing priority of level 1 in the processing priority 440 prior to the update, and when the association score 460 is greater than the first threshold, the data processing center may determine that the updated processing priority 470 in which the sub-gas data has a processing priority of level 2. The first threshold may be determined based on historical data.

In some embodiments of the present disclosure, the importance degree of each entity node is determined by a predetermined algorithm, whereby the association score of the sub-gas data is obtained and the processing priority is updated based on the association score, which helps to perform a fine-grained processing on the sub-gas data with a high importance degree for the association nodes.

Some embodiments of the present disclosure determine the processing priority by considering the requirement characteristics and data characteristics, which allows for different processing strategies to be implemented for sub-gas data with different processing priorities. For example, abnormal data, incomplete data, and large data may be processed in a detailed manner. This maximizes the utilization of limited computing resources and fully meets the processing needs of various data.

FIG. 5 is an exemplary schematic diagram of factors influencing processing requirement characteristics according to some embodiments of the present disclosure.

In some embodiments, the processing requirement characteristics of the sub-gas data are related to a future usage index of the sub-gas data. The future usage index is determined based on future usage data of the sub-gas data, which is predicted using a machine learning model.

The future usage index 550 refers to a frequency of usage of sub-gas data in the future time period. A higher future usage index indicates a higher frequency of usage of sub-gas data in the future time period.

In some embodiments, a future usage index 550 corresponds to future usage data 530 of the sub-gas data

The future usage data 530 refers to a count of times the sub-gas data may be used in a certain future time period. which may be represented using a sequence based on time points. For example, if the sub-gas data may be used x times on the 1st day in the future and y times on the 2nd day in the future, the future usage data of the sub-gas data is represented as (x, y).

In some embodiments, the smart gas data center may obtain the future usage data 530 by using a usage data prediction model 520 based on work plan data 511, source characteristics 512, an associated platform 513, historical usage data 514, and a historical maintenance time 515.

The usage data prediction model 520 refers to a model for determining the future usage data, and in some embodiments, the usage data prediction model may be a machine learning model, such as a Convolutional Neural Network (CNN) model, a Neural Network (NN) model, or the like.

In some embodiments, an input to the usage data prediction model 520 may include the work plan data 511, the source characteristics 512 of the sub-gas data, the associated platform 513, the historical usage data 514 of the sub-gas data, and the historical maintenance time 515, and an output may include the future usage data 530 of the sub-gas data. More about the source characteristics 512 may be found in FIG. 2 and its related description.

In some embodiments, the work plan data 511 may include maintenance plan data, analysis plan data, or the like. The maintenance plan data refers to a plan for periodic maintenance of gas pipeline network device. For example, the maintenance plan data may include that the gas pipeline network device is maintained once a week. The analysis plan data refers to an analysis plan for the smart gas data center to periodically analyze gas user behavior data, gas device operation data, etc.

In some embodiments, the associated platform may include a source platform and a transmission platform for sub-gas data. The transmission platform refers to a platform to which the sub-gas data needs to be sent.

In some embodiments, the historical usage data 514 refers to a count of times the sub-gas data has been used over a certain time period; the historical maintenance time 515 refers to points in the past when nodes such as gas device nodes, gas pipeline nodes, or other nodes in the predetermined knowledge graph have been maintained. In some embodiments, the historical maintenance time 515 may be obtained by looking up a maintenance information registration table.

In some embodiments, the smart gas data center may train the usage data prediction model based on a large number of first training samples with a first label. The first training sample may include sample work plan data, source characteristics of sample gas data, sample associated platform, historical usage data of the sample gas data at a first historical time point or period, and the first label may be actual usage data of the sample gas data at a second historical time point or period.

In some embodiments, the first training sample may be obtained based on historical data, and the first label may be determined by manual annotation. The first historical time point or period occurs before the second historical time point or period.

In some embodiments, the smart gas data center may determine the future usage index based on future usage data. For example, the future usage index may be determined by the following formula (1):

Future usage index=coefficient 1*a predicted count of times the sub-gas data will be used on the first day+coefficient 2*a predicted count of times the sub-gas data will be used on the second day+ . . . +coefficient n, (1)

The coefficients 1, n may be obtained by presetting. For example, the coefficients 1, n decrease in order, indicating that in general the further the future time is from the current time, the worse the prediction accuracy of the usage data prediction model is.

In some embodiments, the future usage index 550 also correlates to a reliability of a future time point corresponding to the future usage data 540.

The reliability of the future time point corresponding to the future usage data 540 refers to an accuracy of predicting future usage data of a certain time point by the usage data prediction model. For example, in the historical usage of the usage data prediction model, the counts of times the 10 pieces of sub-gas data will be used on day 1 were predicted and 10 prediction results were obtained. The 10 prediction results are verified, and 6 of which are accurate, so that the reliability of predicting the future usage data on day 1 by the usage data prediction model is 60%. Likewise, the reliability of predicting the future usage data of other future time points by the usage data prediction model may be determined.

In some embodiments, accurate prediction results refer to the difference between the predicted count and the actual count being less than a difference threshold. The difference threshold may be pre-set, for example, the difference threshold may be 2, etc.

In some embodiments, the reliability of predicting the future usage data of a future time point by the usage data prediction model may be used as the corresponding reliability of the future time point.

In some embodiments, the smart gas data center may update the coefficients 1 to coefficients n in the formula (1) based on the reliability of the future time point, thereby determining the future usage index. The greater the reliability, the greater its corresponding coefficient.

In some embodiments of the present disclosure, a more accurate future usage index may be obtained by updating the coefficients in the formula (1) based on the reliability of the future time point.

In some embodiments, the processing requirement characteristics 560 may be related to the future usage index 550.

In some embodiments, the smart gas data center may determine the processing requirement characteristics based on the future usage index. For example, the processing requirement characteristics may be determined based on the following formula:

Processing requirement characteristics=a*degree of data anomaly+b*degree of data completeness+c*future usage index,

wherein coefficients a, b, and c may be preset.

In some embodiments of the present disclosure, a more accurate future usage index may be obtained by determining the future usage index based on the future usage data through the usage data prediction model, which can result in more reasonable processing requirement characteristics.

One or more embodiments of the present disclosure also provide a non-transitory computer-readable storage medium storing computer instructions, wherein when reading the computer instructions in the storage medium, a computer executes the method for graph-based smart gas data management as described in any of the aforementioned embodiments.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for graph-based smart gas data management, performed by a gas data center of an Internet of Things (IoT) system for smart gas, comprising:
obtaining gas data and source characteristics corresponding to the gas data from a predetermined knowledge graph; wherein
the predetermined knowledge graph is constructed based on gas data obtained from a smart gas platform, the gas data includes at least one of device operation data, gas monitoring data, and user behavior data, and the source characteristics include at least one of a source platform, a source object, and a source collection device; and
nodes in the predetermined knowledge graph include entity nodes and attribute value nodes, the entity nodes include at least one of a gas user node, a gas device node, a gas pipeline node, and a staff node, and edges in the predetermined knowledge graph are determined based on a structure of a gas pipeline network;
dividing the gas data based on the source characteristics to determine one or more sets of sub-gas data;
determining a processing priority of the sub-gas data based on at least one of a degree of data anomaly and a degree of data completeness of the sub-gas data; wherein
the degree of data anomaly and the degree of data completeness are determined based on the predetermined knowledge graph;
determining a resource allocation strategy for computing resources and a processing strategy for the sub-gas data based on the processing priority of the one or more sets of sub-gas data; and
the processing strategy including a processing algorithm and the computing resources; and the processing algorithm including at least one of a data normalization algorithm, an outlier detection algorithm, and a data quality analysis algorithm.

2. The method according to claim 1, wherein the determining a processing priority of the sub-gas data based on at least one of a degree of data anomaly and a degree of data completeness of the sub-gas data includes:
determining processing requirement characteristics of the sub-gas data based on the degree of data anomaly and the degree of data completeness of the sub-gas data; wherein
the degree of data anomaly is determined based on an anomaly of a target node, and the target node is an association node of historical sub-gas data corresponding to the sub-gas data; and
determining the processing priority of the sub-gas data based on the processing requirement characteristics and data characteristics of the sub-gas data.

3. The method according to claim 2, wherein the processing requirement characteristics of the sub-gas data are related to a future usage index of the sub-gas data;
the future usage index is related to future usage data of the sub-gas data; and
the future usage data is determined based on a usage data prediction model, the usage data prediction model being a machine learning model.

4. The method according to claim 3, wherein the future usage index is further related to a reliability of a future time point corresponding to the future usage data.

5. The method according to claim 2, wherein the processing priority of the sub-gas data is further related to an association score of the sub-gas data; wherein
the determining a processing priority of the sub-gas data based on at least one of a degree of data anomaly and a degree of data completeness of the sub-gas data further includes:
determining an importance degree of the entity nodes of the predetermined knowledge graph based on a predetermined algorithm;
determining the association score of the sub-gas data based on the importance degree of the association nodes of the sub-gas data; and
updating the processing priority based on the association score and determining an updated processing priority.

6. The method according to claim 1, wherein the determining a resource allocation strategy for computing resources and a processing strategy for the sub-gas data based on the processing priority of the one or more sets of sub-gas data includes:
obtaining currently available computing resources; and
determining a resource allocation strategy for the available computing resources and the processing strategy for the sub-gas data based on the processing priority, data characteristics, and the available computing resources of the one or more sets of sub-gas data.

7. An Internet of Things (IoT) system for smart gas, comprising a smart gas management platform, wherein the smart gas management platform includes a smart gas data center configured to perform following operations including:
obtaining gas data and source characteristics corresponding to the gas data from a predetermined knowledge graph; wherein
the predetermined knowledge graph is constructed based on gas data obtained from a smart gas platform, the gas data includes at least one of device operation data, gas monitoring data, and user behavior data, and the source characteristics include at least one of a source platform, a source object, and a source collection device; and
nodes in the predetermined knowledge graph include entity nodes and attribute value nodes, the entity nodes include at least one of a gas user node, a gas device node, a gas pipeline node, and a staff node, and edges in the predetermined knowledge graph are determined based on a structure of a gas pipeline network;
dividing the gas data based on the source characteristics to determine one or more sets of sub-gas data;
determining a processing priority of the sub-gas data based on at least one of a degree of data anomaly and a degree of data completeness of the sub-gas data; wherein
the degree of data anomaly and the degree of data completeness are determined based on the predetermined knowledge graph;
determining a resource allocation strategy for computing resources and a processing strategy for the sub-gas data based on the processing priority of the one or more sets of sub-gas data; and
the processing strategy including a processing algorithm and the computing resources; and the processing algorithm including at least one of a data normalization algorithm, an outlier detection algorithm, and a data quality analysis algorithm.

8. The Internet of Things system according to claim 7, further comprising a smart gas user platform, a smart gas service platform, a smart gas sensing network platform, and a smart gas object platform; wherein
the smart gas user platform is configured to collect the user behavior data;
the smart gas service platform is configured to upload the user behavior data to the smart gas management platform;
the smart gas object platform is configured to collect the device operation data or the gas monitoring data; and
the smart gas sensing network platform is configured to upload the device operation data or the gas monitoring data to the smart gas management platform.

9. The Internet of Things system according to claim 7, wherein the smart gas data center is further configured to:
determine processing requirement characteristics of the sub-gas data based on the degree of data anomaly and the degree of data completeness of the sub-gas data; wherein
the degree of data anomaly is determined based on an anomaly of a target node, and the target node is an association node of historical sub-gas data corresponding to the sub-gas data; and
determine the processing priority of the sub-gas data based on the processing requirement characteristics and data characteristics of the sub-gas data.

10. The Internet of Things The system according to claim 9, wherein the processing requirement characteristics of the sub-gas data are related to a future usage index of the sub-gas data;
the future usage index is related to future usage data of the sub-gas data; and
the future usage data is determined based on a usage data prediction model, the usage data prediction model being a machine learning model.

11. The Internet of Things system according to 10, wherein the future usage index is further related to a reliability of a future time point corresponding to the future usage data.

12. The Internet of Things system according to claim 9, wherein the processing priority of the sub-gas data is further related to an association score of the sub-gas data; the smart gas data center is further configured to:
determine an importance degree of the entity nodes of the predetermined knowledge graph based on a predetermined algorithm;
determine the association score of the sub-gas data based on the importance degree of the association nodes of the sub-gas data; and
update the processing priority based on the association score and determine an updated processing priority.

13. The Internet of Things system according to claim 7, wherein the smart gas data center is further configured to:
obtain currently available computing resources; and
determine a resource allocation strategy for the available computing resources and the processing strategy for the sub-gas data based on the processing priority, data characteristics, and the available computing resources of the one or more sets of sub-gas data.

14. A non-transitory computer-readable storage medium storing computer instructions, wherein when reading the computer instructions in the storage medium, a computer executes the method for graph-based smart gas data management according to claim 1.
